(19) United States
(12) Patent Application Publication
(10) Pub. No.: US 2025/0257223 A1
(43) Pub. Date: Aug. 14, 2025

(54) DISPERSIBLE WAX PARTICLES

(71) Applicant: CLARIANT INTERNATIONAL LTD, Muttenz (CH)

(72) Inventors: Milena WUNDLECHNER, Gersthofen (DE); Simon BODENDORFER, Gersthofen (DE)

(73) Assignee: CLARIANT INTERNATIONAL LTD, Muttenz (CH)

(21) Appl. No.: 19/099,793

(22) PCT Filed: Aug. 4, 2023
(86) PCT No.: PCT/EP2023/071733

§ 371 Date: Jan. 30, 2025

(30) Foreign Application Priority Data
Aug. 22, 2022 (EP) 22191371.8

(51) Int. Cl. C09D 5/02; B02C 19/00; C09D 7/45; C09D 7/61; C09D 7/65; C09D 7/80; C09D 123/06; C09D 191/06

(52) U.S. Cl. CPC C09D 5/022; B02C 19/0056; C09D 7/45; C09D 7/61; C09D 7/65; C09D 7/80; C09D 123/06; C09D 191/06

(57) ABSTRACT

The present invention relates to a micronized wax composition, a method for its production, its use for producing an aqueous formulation, an aqueous formulation comprising the micronized wax composition, and a method for producing an aqueous formulation.

The present invention relates to dispersible wax particles and a micronized wax composition, to the use thereof for producing an aqueous formulation, to an aqueous formulation comprising the micronized wax composition and to processes for producing the aqueous formulation.

Waxes and their derivatives are used in numerous areas of industry and in the household, inter alia in care products for the human body, for example cosmetics and hair care products, in care products for floors, furniture, clothing, shoes and automobiles, in medicines and foodstuffs, for example as glazing agents, and in the production of plastics compositions, (hotmelt) adhesives, printing inks, lacquers and other formulations.

DE 10 2013007638 describes a process for producing an acid wax from a mixture of natural wax and polyolefin wax and the use thereof in soaps and shoe polishes.

DE 102018116113 discloses oxidized natural waxes employed inter alia in shoe care products, car care products, floor care products, furniture care products, industrial mold release agents, coating compositions, hydrophobizing agents, adhesives, cosmetic compositions, as production auxiliaries in plastics processing and as release or glazing agents for confectionery and chewing gum.

Liquid wax dispersions are used inter alia for production of lacquers, printing inks and other coatings. However, organic solvents, which are unfavorable from an economic and ecological standpoint and are often concerning to human and animal health, are often used as dispersing media.

EP-A 2970700 describes a lacquer system containing chemically unmodified cellulose, polyolefin and/or Fischer-Tropsch and/or amide and/or bio-based waxes and other components.

The lacquer system has good scratch resistance and is easily redispersible in butyl acetate when components of the lacquer settle. However, many of the described formulations contain organic solvents.

Due to the disadvantages associated with the use of organic solvents, aqueous wax dispersions are becoming increasingly important as they represent a more cost-effective, more environmentally friendly and less toxic alternative to the solvent-containing dispersions.

WO 2006/131147 discloses a composition comprising a biocide and a wax or paraffin for use in water-based paints. The compositions are produced by melting waxes in an aqueous biocide solution at 80° C. to 85° C. and subsequently adding casein as a thickener and a surfactant to the mixture, while paying attention to clumping. The resulting formulation is added to an acrylic lacquer. Due to the elevated temperatures and the multi-step procedure the production of the wax dispersion is complicated for inexperienced users and difficult to perform without the required specialist knowledge.

DE4330342 (BASF) discloses aqueous polyolefin wax dispersions containing polyethylene or polypropylene wax and glycerides reacted with 1,2-alkylene oxides of predominantly unsaturated C₁₆₋₂₂ monocarboxylic acids. These dispersions are produced by incorporating micronized wax into a solution of the dispersing agent in demineralized water.

The finished wax dispersions may be commercially marketed and provided to users in ready-to-use form. However, this often has the disadvantage that, due to the high water content, significantly greater volumes require transportation and storage than if the wax were to be marketed in solid form and only dispersed by the users shortly before use. At the same time the shelf life of aqueous wax dispersions is often poorer than that of the solid wax and the stability of the dispersions is often limited, with the result that the supplied dispersions should be used soon after obtainment.

There is therefore a need for waxes that are easily dispersible in water or in aqueous formulations such as water-based lacquers and printing inks.

Easily dispersible wax particles can allow the user to produce aqueous wax dispersions on site at their own facility and to use them immediately. This inter alia makes it possible to reduce transport and storage costs since only the solid wax need be obtained.

DE 10 2004059060 discloses the production and use of lipophilic waxes that that are easy to stir into oil-based paints and lacquers. Dispersibility in water is not mentioned.

DE 19620810 describes mixtures of non-functionalized polyethylene or polypropylene wax particles with certain hydrophilic dispersants which are present especially in the form of free-flowing powders and are intended for subsequent production of aqueous wax dispersions. The powders are mixtures of non-functionalized polyolefin wax and glycerides reacted with 1,2-alkylene oxides of predominantly unsaturated C₁₆₋₂₂ monocarboxylic acids which may additionally contain hydroxyl groups. Mixing is carried out without addition of water. The obtained products are said to be a free-flowing powder which is easily incorporable upon addition of water. The conditions for the production of a dispersion are not disclosed. The process requires a specific dispersing agent that is not necessarily suitable for each application and knowledge of the production of wax dispersions that is not necessarily accessible to some end users.

US2016018334 discloses the use of an O/W emulsion produced by the PIT process for lubricating conveyor belts in the food industry. Accordingly, this document discloses neither a micronized wax additive nor a dispersion produced by dry comminution of a wax.

Documents U.S. Pat. No. 5,746,812 and WO 2012022389 describe wax dispersions containing micronized waxes. Nowhere in these documents is it described that the wax is subjected to dry comminution together with the emulsifier.

US20090294971 describes the comminution of waxes dispersed with the aid of an emulsifier in a MICROFLUIDIZER® processor to obtain a more stable dispersion. Neither a dry comminution process, nor a product obtained by a dry comminution process is disclosed.

Jian et al, J. Appl. Polymer Sc., Dec. 12, 2012, 1476-1483 describes polyethylene wax (PEW) microspheres produced by the solution-precipitation process using a PEW byproduct as the starting material. Neither a dry comminution process, nor a product obtained by a dry comminution process is disclosed.

DE 10 2015226240 describes rice bran waxes that are bleached and simultaneously polar-modified with an oxygen-containing gas. These have the advantage that they are better-dispersible in water and polar solvents than unmodified rice waxes. However, dispersing such modified waxes requires some knowledge and experience that is not necessarily available to some end users.

There therefore remains a need for dispersible wax compositions that can be dispersed quickly and easily in water and in aqueous formulations such as water-based lacquers and printing inks, thus allowing even an inexperienced end user to produce wax dispersions and allowing easy modification of finished products through admixture of the compositions.

It has now been found that, surprisingly, dry comminution of a wax in the presence of at least one emulsifier affords a micronized wax composition which is rapidly dispersible in water and in water-based formulations, for example by stirring, shaking or even swaying. The speed of dispersion, avoidance of agglomerates and stability of the obtained dispersions are surprisingly markedly better than when mixing the wax with the emulsifier once comminution is already complete. In lacquers and coatings the micronized wax compositions result in good scratch resistance. The micronized wax compositions also exhibit good flowability.

The invention accordingly provides a process for producing a micronized wax composition (C) comprising the step of:
dry comminution of at least one wax (W) in the presence of at least one emulsifier (E), preferably in liquid or dissolved form, and optionally in the presence of at least one density additive (D) having a density at 20° C. of >1 g/cm³, wherein the density additive (D) is substantially insoluble in water at 20° C., and optionally in the presence of at least one further additive (A) distinct from the at least one wax (W), the at least one emulsifier (E) and the at least one density additive (D).

Comminution is to be understood as meaning the division of solid materials into smaller pieces through the action of mechanical forces. Most comminution apparatuses are configured for dry comminution. The comminution of pasty to liquid dispersions is known as wet comminution (cf. Römpp, 9th edition).

Dry comminution can cause heating of the particles for comminution. If the heating becomes excessive, water may be used for cooling. However, this comminution with cooling is not to be equated to a wet comminution since the amount of water is kept low enough not to alter the product properties. If the dry comminution is carried out in a mill the emulsifier (E) is dosed into the milling chamber via a volumetric or gravimetric dosing during milling of the wax (W).

In the context of the invention the melting of a solid wax which is subsequently comminuted by spraying in a spraying tower is also referred to as dry comminution. In “dissolved form” is to be understood as meaning that the emulsifier is present in the solvent in highly concentrated form, i.e. precisely enough solvent is employed for the required amount of emulsifier to be completely dissolved and for the emulsifier to be sprayed or pumped. However, the amount of solvent should not exceed the amount of solvent required for complete dissolution by more than 30%.

This limitation of the solvent amount is necessary in order that the micronized wax composition (C) is not obtained as a solid/solvent mixture (dispersion), the coating of the wax particles with the emulsifier is ensured and thus the advantageous properties of micronized wax composition are retained.

It is preferable when the dry comminution employs less than 20% by weight of water, particularly preferably less than 10% by weight, very particularly preferably less than 5% by weight, based on the total amount of the wax used for comminution.

The invention further provides a micronized wax composition (C) comprising:
a) at least one wax (W);
b) at least one emulsifier (E);
c) optionally at least one density additive (D) having a density at 20° C. of >1 g/cm³, preferably >1.3 g/cm³, wherein the density additive (D) is substantially insoluble in water at 20° C.; and
d) optionally at least one further additive (A) distinct from the at least one wax (W), the at least one emulsifier (E) and the at least one density additive (D);
wherein the micronized wax composition (C) is obtained by dry comminution of the at least one wax (W) in the presence of the at least one emulsifier (E), preferably in liquid or dissolved form and optionally in the presence of the at least one density additive (D) and/or the at least one further additive (A).

It is preferable when the water content of the micronized wax composition (C) is less than 20% by weight, particularly preferably less than 10% by weight, very particularly preferably less than 5% by weight, based on the total weight of the micronized wax composition (C). The water content is determined with an HR73 halogen moisture analyzer from Mettler Toledo by analyzing a predetermined amount (between 2 and 7 g) of the sample (accuracy±0.0001 g) at 105° C. The measurement is performed according to manufacturer specifications. If the weight loss is less than 1 mg after 90 seconds, the measurement is terminated after this time and the water content determined.

The micronized wax composition preferably consists of these components. Accordingly the wax composition (C) according to the invention is obtainable by the process according to the invention.

The expression “substantially insoluble in water at 20° C.” is to be understood as meaning that at 20° C. at most 20 g, preferably at most 10 g, more preferably at most 5 g, more preferably at most 1 g of the density additive (D) are dissolvable in 1 L water.

The expression “micronized” in the present context means that the (average) particle size of the substance in question has been reduced compared to the original state, and less than 1% by volume of the particles have a particle size of 1000 μm or more.

Particle size distributions can be measured, for example, by the laser diffraction method, as described, for example, in “A Guidebook to Particle Size Analysis” (Horiba Instruments, Inc., 2019). A measuring instrument suitable for the purpose is, for example, LA-960 from Horiba Instruments, Inc., which can measure particle sizes in the range from 10 nm to 5 mm, or Mastersizer 3000 from Malvern Panalytical, which can measure particle sizes in the range from 10 nm to 3.5 mm.

It is preferable when the micronized wax composition (C) comprises:
a) 40% to 99.9% by weight, preferably 50% to 99% by weight, more preferably 60% to 98.8% by weight, more preferably 65% to 98.5% by weight, more preferably 70% to 98% by weight, based on the weight of the micronized wax composition (C), of the at least one wax (W);
b) 0.1% to 20% by weight, preferably 1% to 15% by weight, more preferably 1.2% to 8% by weight, more preferably 1.5% to 5% by weight, more preferably 2% to 4% by weight, based on the weight of the micronized wax composition (C), of the at least one emulsifier (E);
c) optionally 0% to 59.9% by weight, preferably 0% to 45% by weight, more preferably 0% to 38% by weight, more preferably 0% to 30% by weight, more preferably 0% to 26% by weight, based on the weight of the micronized wax composition (C), of the at least one density additive (D); and
d) optionally 0% to 50% by weight, preferably 0% to 45% by weight, more preferably 0% to 38% by weight, more preferably 0% to 30% by weight, more preferably 0% to 26% by weight, based on the weight of the micronized wax composition (C), of the at least one further additive (A).

It is preferable when a), b), c) and d) sum to 100% by weight of the micronized wax composition (C), so that the micronized wax composition (C) consists of the at least one wax (W), the at least one emulsifier (E), optionally the at least one density additive (D) and optionally the at least one further additive (A).

When the at least one density additive (D) is present, the amount thereof is typically at least 0.1% by weight, preferably at least 1% by weight, more preferably at least 5% by weight, based on the weight of the micronized wax composition (C). In these cases the upper limit of the amount of wax (W) is adapted accordingly such that the sum of the components does not exceed 100% by weight.

When the at least one further additive (A) is present, the amount thereof is typically at least 0.01% by weight, preferably at least 0.1% by weight, more preferably at least 1% by weight, based on the weight of the micronized wax composition (C). In these cases the upper limit of the amount of wax (W) is adapted accordingly such that the sum of the components does not exceed 100% by weight.

The invention further provides an aqueous formulation comprising water and 0.01% to 60% by weight, preferably 0.1% to 50% by weight, more preferably 0.2% to 4% by weight or 30% to 40% by weight, more preferably 0.3% to 3% by weight or 32% to 38% by weight, based on the total weight of the aqueous formulation, of micronized wax composition (C), wherein the micronized wax composition (C) is dispersed in the water.

The invention further provides a process for producing an aqueous formulation comprising the steps of:
i) providing water, the micronized wax composition (C), and optionally further components;
ii) mixing the components provided in step i), preferably by stirring, shaking or swaying.

The invention further provides for the use of a micronized wax composition (C) for producing an aqueous formulation and to the use of the micronized wax composition (C) according to the invention and/or a wax concentrate obtained therefrom for improving the scratch resistance of a coating or a lacquer produced from a ready-to-use aqueous formulation.

The micronized wax composition (C) according to the invention and its components that are employed in the process according to the invention are more particularly described below.

### Wax (W)

The wax (W) present in the micronized wax composition (C) may in principle be any desired wax. The wax (W) may for example be selected from the group consisting of synthetic organic waxes, semisynthetic organic waxes, natural waxes (biobased waxes) and mixtures thereof, wherein the wax may optionally be oxidized or otherwise chemically modified.

Suitable wax components are synthetic hydrocarbon waxes, e.g. polyolefin waxes. These may be produced by thermal degradation of branched or unbranched polyolefin polymers or by direct polymerization of olefins. Suitable polymerization processes include for example free-radical processes, wherein the olefins, generally ethylene, are converted at high pressures and temperatures into polymer chains having a greater or lesser degree of branching, as well as processes in which ethylene and/or higher 1-olefins, for example propylene, 1-butene, 1-hexene etc., are polymerized with the aid of organometallic catalysts, for example Ziegler-Natta or metallocene catalysts, to afford unbranched or branched waxes.

Corresponding methods of producing olefin homo- and copolymer waxes are described for example in Ullmann's Encyclopedia of Industrial Chemistry, 5th Edition, Vol. A 28, Weinheim 1996, Chapter 6.1.1./6.1.2. (High-pressure polymerisation (waxes), Chapter 6.1.2. (Ziegler-Natta polymerisation, polymerisation with metallocene catalysts) and Chapter 6.1.4. (Thermal degradation).

In addition, it is possible to use what are called Fischer-Tropsch waxes. These are produced catalytically from synthesis gas and differ from polyethylene waxes by lower average molar masses, narrower molar mass distributions and lower melt viscosities.

The employed hydrocarbon waxes may be unfunctionalized or functionalized by polar groups.

The incorporation of such polar functions may be carried out subsequently by corresponding modification of the nonpolar waxes, for example by oxidation with air or by grafting on polar olefin monomers, for example α,ß-unsaturated carboxylic acids and/or derivatives thereof, for instance acrylic acid or maleic anhydride. Polar waxes may further be produced by copolymerization of ethylene with polar comonomers, for example vinyl acetate or acrylic acid, as well as by oxidative degradation of relatively high molecular weight non-waxy ethylene homo- and copolymers. Corresponding examples may be found for instance in Ullmann's Encyclopedia of Industrial Chemistry, 5th Edition, Vol. A 28, 1996, Chapter 6.1.5.

Suitable polar waxes further include amide waxes, such as are obtainable for example by reacting longer-chain carboxylic acids, for example fatty acids, with mono- or polyfunctional amines. Fatty acids typically used for this purpose have chain lengths in the range between 12 and 24, preferably between 16 and 22, carbon atoms and may be saturated or unsaturated. Preferably employed fatty acids include the C16- and C18-acids, in particular palmitic acid and stearic acid or mixtures of both acids. Suitable amines other than ammonia include especially polyfunctional, for example difunctional, organic amines, wherein ethylenediamine is preferable. Particular preference is given to the use of the wax which is commercially available under the name EBS wax (ethylene bisstearoyl diamide) and produced from technical stearic acid and ethylenediamine.

In addition, it is possible to use biobased waxes, which are generally ester waxes. In general, biobased waxes mean those waxes that are formed on a renewable raw material basis. These may be either native or chemically modified ester waxes. Typical native biobased waxes are described in Ullmann's Encyclopedia of Industrial Chemistry, 5th in addition, vol. A 28, 1996, chapter 2. These include palm waxes such as carnauba wax, grass waxes such as candelilla wax, sugarcane wax and straw waxes, beeswax, rice wax, etc. Chemically modified waxes are usually formed from the ester waxes or vegetable oil-based fatty acids by oxidation (for example by a mixture of CrO₃ and H₂SO₄), esterification, transesterification, amidation, hydrogenation, etc. Examples of these also include metathesis products of vegetable oils.

The biobased waxes are additionally also include montan waxes, either in unmodified or refined/derivatized form. Details of such waxes may be found for example in Ullmann's Encyclopedia of Industrial Chemistry, 5th edition, vol. A 28, 1996, chapter 3 (Waxes).

Prior to the dry comminution the wax (W) may have any desired particle size. For example the wax (W) may be a granulate having a particle diameter of >1 mm, for example 2 to 10 mm. However, prior to the dry comminution the wax (W) may also have particle diameters of ≤1 mm, for example 200 to 900 μm.

The micronized wax composition (C) according to the invention exhibits good dispersibility in water and in water-based formulations such as water-based lacquers and printing inks even if the wax (W) as such essentially does not form a stable dispersion in water. Functional groups which can increase the dispersibility of the wax are therefore unnecessary. However, the wax (W) may also contain functional groups that influence certain properties of the wax.

In one embodiment the wax (W) thus essentially does not form a stable dispersion in water. In the present context this is the case when after incorporation of the wax (W) in water at 20° C. (about 10% by weight of wax) in the absence of an emulsifier with a laboratory blade stirrer at a stirring speed of 700 rpm for 5 min visible phase separation occurs within 1 hour.

In such an embodiment the wax (W) is preferably not oxidized, and is not grafted or copolymerized with heteroatom-containing groups. It is preferable when the wax (W) in this embodiment contains no polar groups.

While oxidation and grafting can have a positive effect on the dispersibility of a wax (W) in water and water-based formulations they can also have an adverse effect on other properties of the wax. This embodiment is often relevant for synthetic or semisynthetic waxes, especially for polyolefin waxes, whose properties are often adjusted through the selected synthesis conditions and where alteration of these properties is undesired.

Such waxes (W) preferably have an acid number (measured according to DIN EN ISO 2114:2000) and preferably a saponification number (measured according to DIN EN ISO 3681:2018) and/or hydroxyl number (measured according to DIN EN ISO 2554:1997) of in each case 0 to 40 mg KOH/g, preferably 0 to 20 mg KOH/g, more preferably 0 to 10 mg KOH/g. Polyolefin waxes may be produced inter alia by Ziegler-Natta catalysis or by metallocene catalysis, preferably metallocene catalysis, and preferably have an acid number of 0 to 5 mg KOH/g.

The wax may generally be selected from polyolefin waxes, mineral waxes, montan wax, rice bran wax, beeswax, sunflower wax, corn wax, carnauba wax, Fischer-Tropsch waxes, paraffin waxes, ester waxes and amide waxes. The wax is preferably selected from polyethylene wax, polypropylene wax, poly(ethylene-co-propylene) wax, rice bran wax, corn wax and sunflower wax, and is more preferably HDPE wax (high density polyethylene).

Micronized wax compositions (C) in which the pure wax (W) contains polar groups exhibit a markedly improved dispersibility. Thus in a further embodiment the wax (W) may contain polar groups and may preferably be oxidized, grafted with heteroatom-containing groups or otherwise chemically modified.

Oxidation is also relevant inter alia for natural waxes, in particular montan wax, rice bran wax, sunflower wax, corn wax and carnauba wax, since these are typically dark-colored in the raw state and may be bleached by oxidation for example. In the case of waxes (W) containing polar groups, for example in the case of oxidized natural waxes, the acid number is often greater than 15 mg KOH/g, preferably between 20 and 200 mg KOH/g.

The acid number may be in the range from 45 to 70 mg KOH/g or in the range from 70 to 170 mg KOH/g for example. Such waxes may also have been further derivatized, for example by esterification, amidation or saponification.

However, the wax (W) may also have been derivatized in other ways prior to micronization. For example, waxes, preferably polyolefin waxes, may be grafted with heteroatom-containing groups. These include for example waxes grafted with carboxylic acid derivatives having ethylenically unsaturated groups. It is preferable when such derivatized waxes are grafted with heteroatom-containing groups selected from the group consisting of acrylic acid, alkyl acrylates, acrylamides, methacrylic acid, alkyl methacrylates, methacrylamides, maleic acid, alkyl maleates, maleic anhydride and maleimide, more preferably maleic acid, maleic anhydride and maleimide, more preferably maleic anhydride. The wax grafted with these groups is preferably a polyethylene wax, polypropylene wax or poly(ethylene-co-propylene) wax, more preferably a polyethylene wax or a polypropylene wax, more preferably an HDPE wax.

It is preferable when the wax (W) is a polyolefin wax having a dropping point (measured according to DIN ISO 2176:1995) in the range from 100° C. to 160° C., more preferably in the range from 110° C. to 150° C., more preferably from 120° C. to 145° C., more preferably from 125° C. to 135° C., and a density in the range from 0.88 to 1.06 g/cm³, more preferably in the range from 0.90 to 1.02 g/cm³, more preferably in the range from 0.90 to 1.00 g/cm³, more preferably in the range from 0.90 to 0.98 g/cm³.

### Emulsifier (E)

The emulsifier (E) may be any desired emulsifier that can improve the dispersibility of nonpolar solids in polar media, especially water. Suitable emulsifiers include nonionic, anionic, cationic and amphoteric surfactants.

Suitable nonionic surfactants include for example fatty alcohol alkoxylates, which may optionally be alkyl-terminated, fatty acid alcoxylates, which may optionally be alkyl-terminated, alkyl glucosides, alkyl polyglucosides, alkylphenol ethoxylates, fatty acid esters of polyglycerols and alkoxylated fatty acid glycerides. Preferred nonionic surfactants include C₈-C₃₀ fatty alcohol alkoxylates and C₈-C₃₀ fatty acid alkoxylates having 1 to 100, preferably 2 to 50, more preferably 3 to 10, alkylene oxide units, preferably ethylene oxide and/or propylene oxide units, more preferably ethylene oxide units.

Suitable anionic surfactants include for example fatty acid salts, alkylbenzenesulfonic acid salts, alkylsulfonic acid salts, fatty alcohol sulfates, alkyl ether sulfates, sulfoacetates and taurides. Preferred anionic surfactants include alkali metal salts of C8-C30 fatty acids, alkali metal salts of C8-C30 alkylbenzenesulfonic acids and alkali metal salts of C8-C30 alkylsulfonic acids.

Suitable cationic surfactants include for example quaternary ammonium salts, preferably halides, more preferably chlorides, such as tetraalkylammonium salts having 1, 2 or 3 C₈-C₃₀ alkyl radicals and 3, 2 or 1 C₁-C₄ alkyl radicals, and quaternary ammonium salts of alkanolamine fatty acid esters (esterquats). Preferred cationic surfactants are C₈-C₃₀ alkyltrimethylammonium salts, di(C₈-C₃₀ alkyl)dimethylammonium salts and esterquats based on quaternized triethanolamine esters with C₈-C₃₀ fatty acids.

Suitable amphoteric surfactants include for example betaine derivatives containing long-chain alkyl groups, preferably C₅-C₃₀ alkyl groups, and sulfobetaines containing long-chain alkyl groups, preferably C₅-C₃₀ alkyl groups.

It is preferable when the emulsifier (E) is a nonionic emulsifier, for example a nonionic surfactant. It is more preferable when the emulsifier (E) is a non-ionic emulsifier which is liquid at 20° C. or is soluble in water at 20° C.

The nature of a nonionic emulsifier may be described for example via the mass ratio between the polar and the nonpolar portion of a surfactant and is defined by the HLB value (“hydrophilic-lipophilic balance”, the hydrophilic-lipophilic ratio of the molecule). The level of this hydrophilic-lipophilic ratio can be determined by calculation of values for the different regions of the molecule, as described by Griffin (cf., for example, Journal of the Society of Cosmetic Chemists, 5 (4), 249-256 (1954)). The Griffin method was developed primarily for nonionic surfactants; the HLB value is calculated by the following formula:

$$HLB = 20 * Mh / M ,$$

where Mh is the molecular mass of the hydrophilic part of the molecule and M is the molecular mass of the overall molecule, which results in a value on a scale from 0 to 20.

An HLB value of 0 corresponds to a completely lipophilic molecule; an HLB value of 20 corresponds to a completely hydrophilic molecule.

The emulsifier (E) which is employed in the process according to the invention and is present in the wax composition (C) is preferably a nonionic emulsifier having an HLB value in the range from 6 to 16, preferably 7 to 15, more preferably 9 to 13, more preferably 10 to 12.

The emulsifier (E) is present in the micronized wax composition (C) preferably in an amount of 0.1% to 20% by weight, more preferably 1% to 15% by weight, more preferably of 1.2% to 8% by weight, more preferably 1.5% to 5% by weight, more preferably of 2% to 4% by weight, based on the weight of the micronized wax composition (C).

### Optional Density Additives (D)

The micronized wax composition (C) may optionally contain a density additive (D) having a density at 20° C. of >1 g/cm³, preferably >1.1 g/cm³, more preferably 1.2 to 10.0 g/cm³, more preferably 1.3 to 5 g/cm³, more preferably 1.4 to 4.8 g/cm³.

The density additive (D), if present, is used to increase the density of the micronized wax composition (C) such that, to the greatest extent possible, it does not float on the aqueous phase during dispersion in water. For this reason, the density additive (D) must be substantially insoluble in water at 20° C. An additive that is readily soluble in water would increase the density of the aqueous phase and thus have the opposite effect.

The amount of the density additive (D) in the micronized wax composition (C) is preferably selected such that the density of the micronized wax composition (C) is approximately equal to or slightly higher than the density of the water. If the micronized wax composition (C) is intended for dispersion in an aqueous solution having a higher or lower density than pure water the amount of the density additive (D) may also be selected such that the density of the micronized wax composition (C) is approximately equal to or slightly higher than the density of this aqueous solution.

It is preferable when the amount of the density additive (D) in the micronized wax composition (C) is selected such that the density of the micronized wax composition (C) at 20° C. is in the range from 0.94 to 1.20 g/cm³, preferably from 0.96 to 1.10 g/cm³, more preferably from 0.98 to 1.06 g/cm³, more preferably from 1.00 to 1.04 g/cm³.

The density additive (D) may be an organic additive or an inorganic additive.

Organic density additives (D) may have for example a density in the range from 1.1 to 2.8 g/cm³, preferably 1.3 to 2.5. Suitable organic density additives (D) include inter alia halogenated organic polymers such as polyvinyl chloride, polyvinylidene chloride, polyvinyl fluoride, polyvinylidene fluoride and polytetrafluoroethylene (PTFE), polyamides and aramides and polysaccharides or polyglucosides such as cellulose, hemicellulose, starch, chitin, chitosan and the like. Preferred organic density additives (D) are PTFE waxes and cellulose, more preferably PTFE waxes.

Inorganic density additives (D) may have for example a density in the range from 2.0 to 10.0 g/cm³, preferably from 2.1 to 5.0 g/cm³, more preferably 2.5 to 4.8 g/cm³. Suitable inorganic density additives (D) include inter alia inorganic salts and minerals that are substantially insoluble. Examples of suitable inorganic density additives (D) are silicon dioxide, magnesium carbonate, magnesium fluoride, calcium carbonate, calcium sulfate, calcium fluoride, strontium carbonate, strontium sulfate, strontium fluoride, barium carbonate, barium sulfate and barium fluoride. Preferred inorganic density additives (D) are poorly soluble salts of alkaline earth metals, more preferably calcium sulfate, calcium carbonate, barium sulfate or barium carbonate, more preferably calcium carbonate.

### Optional Further Additives (A)

The micronized wax composition (C) may optionally comprise at least one further additive (A) distinct from the at least one wax (W), the at least one emulsifier (E) and the at least one density additive (D).

Further additives (A) may be any desired additives that do not substantially influence the dispersibility of the micronized wax composition (C) in water. Further additives (A) may comprise for example customary wax additives that increase the stability of the waxes toward external influences.

Suitable further additives (A) include for example antioxidants, UV stabilizers, thermal stabilizers, plasticizers, wetting auxiliaries, defoamers, processing auxiliaries, thixotropic agents, gelling agents, thickeners, release agents, flow-control agents, fragrances, antimicrobial agents, dyes and pigments. In the present context solvent residues, for example water, are also included in the further additives (A). These may be present for example if the at least one emulsifier (E) or another additive (A) is employed in dissolved form.

If present, the further additives (A) are employed in the amounts customary for these additives. For example, the further additives (A) may be present in a total amount of 0.01% to 50% by weight, preferably 0.05% to 45% by weight, more preferably 0.1% to 38% by weight, more preferably 0.1% to 30% by weight, more preferably 0.1% to 26% by weight, based on the weight of the micronized wax composition (C).

### Process for Producing the Micronized Wax Composition (C)

The micronized wax composition (C) is obtained by dry comminution of the at least one wax (W) in the presence of the at least one emulsifier (E).

If present, the optional density additive (D) and/or the optional further additive (A) may likewise be present during the dry comminution or only be admixed with the micronized wax composition after the dry comminution. It is preferable when at least the optional density additive (D), more preferably also the optional further additive (A), is present during the dry comminution of the wax (W).

In the dry comminution of the at least one wax (W) the at least one emulsifier (E) may be present in solid, liquid or dissolved form. When the emulsifier is in solid form the wax (W) is typically mixed with the emulsifier (E) in the dry state and subsequently comminuted together therewith or the solid emulsifier (E) is dosed into the grinding chamber via a volumetric or gravimetric dosing during milling of the wax (W).

However, it is preferable when the at least one emulsifier (E) is in liquid or dissolved form during the dry comminution of the at least one wax (W). This often results in an even better dispersibility of the resulting micronized wax composition (C).

This means that the supply of the emulsifier (E) and the dry comminution of the wax (W) in the presence of the emulsifier (E) is preferably carried out at a temperature exceeding the melting temperature of the emulsifier (E) when the emulsifier (E) is not in dissolved form.

Accordingly, the supply and dry comminution may be carried at room temperature when the emulsifier is liquid at room temperature as is the case for many nonionic surfactants. In the case of emulsifiers which are solid at room temperature but may be converted into the liquid state by melting, the dry comminution of the wax (W) may preferably be carried out at a correspondingly higher temperature.

In these cases the melting temperature of the emulsifier (E) is preferably at least 10° C. below the melting temperature of the wax (W). Otherwise, a partial softening/melting of the wax (W) may impair the dry comminution process.

The emulsifier (E) may alternatively also be employed in dissolved form, for example in aqueous solution. This is particularly useful for emulsifiers (E) which have a high melting point and therefore cannot be provided in liquid form without also melting the wax (W) or which undergo thermal degradation before they can be converted into the liquid state. This is the case for some ionic surfactants.

Provision of the emulsifier (E) in dissolved form may likewise be advantageous since this allows better distribution of the emulsifier (E). During provision of the emulsifier (E) in dissolved form the optional density additives (D) and the optional further additives (A) may simultaneously also be provided dispersed or dissolved in the same solution. It is preferable when the emulsifier (E) is an emulsifier liquid at room temperature and/or is provided in aqueous solution.

It is preferable when the emulsifier (E) is introduced to the wax (W) by spraying in liquid or dissolved form during comminution of the wax (W).

The dry comminution may be carried out by any comminution methods which allow dry comminution of wax in the presence of an emulsifier (E), preferably in liquid or dissolved form. It is preferable when the micronized wax composition (C) after the dry comminution has a volume median value D₅₀ of the particle sizes (measured in water with a Mastersizer 3000 from Malvern Panalytical) in the range from 3 to 30 μm, more preferably from 4 to 20 μm, more preferably from 5 to 15 μm, more preferably from 7 to 10 μm. It is further preferable when at least 99% by volume of the particles of the micronized wax composition (C) have a size of at most 100 μm, more preferably at most 80 μm, more preferably at most 60 μm, more preferably at most 30 μm, after the dry comminution.

Such particle sizes may be obtained using a suitable mill. Such mills include for example impact mills, hammer mills, pin mills and jet mills.

It is preferable to employ a mechanical impact mill or an air jet mill provided with a classifier. Suitable mills and classifiers are marketed for example by Hosokawa Alpine AG. The emulsifier (E) may be sprayed into the grinding chamber via a nozzle (in liquid or dissolved form) or initially charged together with the wax (W). The emulsifier (E) is preferably sprayed into the grinding chamber in liquid or dissolved form.

It is preferable to employ the following amounts of components in the dry comminution:
a) 40% to 99.9% by weight, preferably 50% to 99% by weight, more preferably 60% to 98.8% by weight, more preferably 65% to 98.5% by weight, more preferably 70% to 98% by weight, based on the total weight of the employed components, of the at least one wax (W);
b) 0.1% to 20% by weight, preferably 1% to 15% by weight, more preferably 1.2% to 8% by weight, more preferably 1.5% to 5% by weight, more preferably 2% to 4% by weight, based on the total weight of the employed components, of the at least one emulsifier (E);
c) optionally 0% to 59.9% by weight, preferably 0% to 45% by weight, more preferably 0% to 38% by weight, more preferably 0% to 30% by weight, more preferably 0% to 26% by weight, based on the total weight of the employed components, of the at least one density additive (D); and
d) optionally 0% to 50% by weight, preferably 0% to 45% by weight, more preferably 0% to 38% by weight, more preferably 0% to 30% by weight, more preferably 0% to 26% by weight, based on the total weight of the employed components, of the at least one further additive (A).

It is preferable when a), b), c) and d) sum to 100% by weight, so that no further components are employed.

When the at least one density additive (D) is employed the amount thereof is typically at least 0.1% by weight, preferably at least 1% by weight, more preferably at least 5% by weight, based on the total weight of the employed components. In these cases the upper limit of the employed amount of wax (W) is adapted accordingly such that the sum of the components does not exceed 100% by weight.

The density additive (D) may be co-dosed into the grinding chamber either volumetrically or gravimetrically to achieve the corresponding composition for the wax composition (C) or gravimetrically premixed with the wax.

When the at least one further additive (A) is employed the amount thereof is typically at least 0.01% by weight, preferably at least 0.1% by weight, more preferably at least 1% by weight, based on the total weight of the employed components. In these cases the upper limit of the employed amount of wax (W) is adapted accordingly such that the sum of the components does not exceed 100% by weight.

The wax composition (C) according to the invention may be used for producing an aqueous formulation.

It has surprisingly been found that the wax composition (C) according to the invention can be dispersed much faster in water or water-based lacquers and water-based inks than similar compositions where the wax (W) is mixed with an emulsifier (E) only after micronization. Without wishing to be bound to a particular theory it is thought that the dry comminution of the wax (W) in the presence of the emulsifier (E) brings about more uniform wetting of the surface of the wax particles than in the case of mixing after the micronization, thus markedly facilitating and accelerating the subsequent dispersion in water and in addition allowing a reduced use of emulsifiers in the wax composition (C) according to the invention.

The process according to the invention for producing an aqueous formulation comprises the steps of: i) providing water, the inventive micronized wax composition (C) and optionally further components; ii) mixing the components provided in step i).

The provision of the micronized wax composition (C) according to the invention in step i) may be carried out for example when the at least one wax (W) is comminuted immediately before step ii) in the presence of the at least one emulsifier (E), preferably in liquid or dissolved form, and optionally in the presence of the at least one density additive (D) and/or the at least one further additive (A). Alternatively a storage of the micronized wax composition (C) may be carried out between the dry comminution and the mixing in step ii).

In the process the amounts of micronized wax composition (C), water and optionally further components, and optionally the type of further components, are selected according to the desired concentration in the aqueous formulation which is more particularly described hereinbelow.

Mixing may be carried out by any desired process. For example mixing may be effected by stirring, shaking or even swaying of the components. Other processes for mixing may also be employed, for example mixing using static mixers, by producing turbulences through conduction of gases or via ultrasound.

Stirring may be carried out for example using a mechanical stirrer such as a KPG stirrer, a hand mixer, a wand mixer, a blender, a disperser, a blade stirrer, a magnetic stirrer or by hand (for example with a spatula or spoon). Shaking and swaying may likewise be carried out manually or by automated processes, wherein in the present context swinging represents a gentler form of shaking where a mixing with the gas phase to form bubbles is ideally avoided by avoiding for example vertical motions of the vessel, or the components to be mixed, to the greatest extent possible.

Suitable apparatuses for shaking and/or swaying include for example shakers, rotators, bottle rollers, tumble mixers and vibratory apparatuses.

It is preferable when mixing is effected by stirring or shaking, more preferably by stirring.

The aqueous formulation according to the invention comprises water and 0.01% to 60% by weight, preferably 0.1% to 50% by weight, more preferably 0.2% to 4% by weight or 30% to 40% by weight, more preferably 0.3% to 3% by weight or 32% to 38% by weight, based on the total weight of the aqueous formulation, of micronized wax composition (C), wherein the micronized wax composition (C) is dispersed in the water.

In addition, the aqueous formulation may also contain further components. These further components may be selected as desired and are typically selected according to the end use of the aqueous formulation. The other components may also include individual ingredients of the micronized wax composition (C) in additional quantities. The further components may contain for example additional emulsifiers (E), density additives (D) and/or further additives (A), even if these are already present in the micronized wax composition (C).

The further components may contain for example stabilizers such as antioxidants, UV stabilizers and thermal stabilizers, plasticizers, wetting auxiliaries, defoamers, processing auxiliaries, thixotropic agents, gelling agents, thickeners, fragrances, antimicrobial agents, dyes and pigments, polymers, film-formers, fillers, resins and/or hardening accelerators.

The aqueous formulation according to the invention may be an aqueous concentrate or may already be a ready-to-use aqueous product, for example a water-based lacquer or a water-based printing ink. The aqueous formulation is preferably an aqueous wax concentrate, a water-based flexography printing ink, a water-based polyurethane lacquer or a water-based acrylic lacquer.

As a wax concentrate the aqueous formulation typically comprises 20% to 60% by weight, preferably 25% to 50% by weight, more preferably 30% to 40% by weight, more preferably 32% to 38% by weight, based on the total weight of the aqueous formulation, of micronized wax composition (C).

It is preferable when the wax concentrate additionally comprises at least one thickener, preferably selected from methyl cellulose, xanthan gum, gelatine and agar, more preferably methyl cellulose. Suitable amounts of thickener are typically between 0.01% and 20% by weight, preferably between 0.05% and 10% by weight, more preferably between 0.1% and 1% by weight, based on the total weight of the aqueous formulation.

In one embodiment the aqueous formulation comprises a wax concentrate comprising water and 30% to 40% by weight, preferably 32% to 38% by weight, more preferably 34% to 36% by weight, based on the total weight of the aqueous formulation, of micronized wax composition (C) and a thickener, preferably selected from methylcellulose, xanthan gum, gelatine and agar, more preferably methyl cellulose. A wax concentrate for universal application may for example consist of the micronized wax composition (C), water and thickener, and be admixed with further components such as fragrances, dyes, etc. only for production of a ready-to-use aqueous product.

As ready-to-use aqueous products, for example as water-based lacquers or water-based printing inks, the aqueous formulation typically comprises 0.01% to 20% by weight, preferably 0.05% to 15% by weight, more preferably 0.1% to 10% by weight, more preferably 0.2% to 4% by weight, more preferably 0.3% to 3% by weight, based on the total weight of the aqueous formulation, of micronized wax composition (C). In addition, such ready-to-use aqueous products typically comprise further components that are customary for the particular type of product.

Ready-to-use aqueous products such as lacquers and printing inks may be produced directly from the micronized wax composition (C) by mixing with water and the further components or be obtained from a wax concentrate by mixing with the further components. The wax concentrate or the micronized wax composition (C) may likewise be incorporated directly into a lacquer or a printing ink in order for example to improve the scratch resistance of a ready-to-use lacquer or a printing ink.

The invention is more particularly elucidated by the examples which follow and the claims.

### EXAMPLES

### Employed Materials:

W1: Licowax® PE 130 GR (Clariant SE): HDPE wax granulate having a granulate diameter of about 7 mm, a dropping point of 127° C. to 132° C., an acid number of 0 mg KOH/g and a density of 0.96 to 0.98 g/cm³.

W2: Licocene® PE 4201 GR (Clariant SE): HDPE wax granulate having a granulate diameter of about 5 mm, a dropping point of 125° C. to 130° C., an acid number of 0 mg KOH/g and a density of 0.96 to 0.98 g/cm³.

W3: micronized HDPE wax having a D50 value (volume median) of 7.5 to 9.5 μm, a dropping point of 127° C. to 132° C., an acid number of 0 mg KOH/g and a density of 0.96 to 0.98 g/cm³, produced by dry comminution of W1 as described in production example 1 (without emulsifier and density additive).

W4: Ceridust® 3715 (Clariant SE): micronized oxidized HDPE wax having a D50 value of 7.5 to 9.5 μm, a dropping point of 122° C. to 127° C., an acid number of 2-5 mg KOH/g and a density of 0.96 to 0.98 g/cm³.

W5: Luwax® AF 30 (BASF SE): micronized HDPE wax having a D50 value of about 6.5 μm, a dropping point of 112° C. to 120° C., an acid number of 1 to 3.6 mg KOH/g and a density of 0.94 to 0.96 g/cm³.

W6: ACumist® A12 (Honeywell, Inc.): micronized oxidized HDPE wax having a D50 value of 10 to 13 μm, a dropping point of about 137° C., an acid number of 26 to 40 mg KOH/g and a density of about 0.99 g/cm³.

W7: Ceridust® 1060 Vita (Clariant SE): micronized oxidized rice bran wax having a D50 value of 11-14 μm, a dropping point of 75-80° C., an acid number of 45-55 mg KOH/g and a density of about 0.99 g/cm³.

W8: Licocare RBW 102 FL Vita (Clariant SE): oxidized rice bran wax flakes having a flake diameter of 2-5 mm, a dropping point of 75-80° C., an acid number of 45-55 mg KOH/g and a density of about 0.99 g/cm³.

W9: Ceridust® 1041 Vita (Clariant SE): micronized oxidized rice bran wax having a D50 value of 6-9 μm, a dropping point of 75-82° C., an acid number of 15-25 mg KOH/g and a density of about 0.99 g/cm³.

E1: nonionic emulsifier, fatty alcohol polyglycol ether having an HLB value of about 11.

E2: plant-based nonionic emulsifier, palm-fat alcohol polyglycol ether having an HLB value of about 10 to 12.

D1: Barium sulfate powder having a D50 value of about 5 μm; density 4.5 g/cm³.

D2: Low molecular weight PTFE wax having a median particle size (determined according to ASTM D4894) of 4 μm; density about 2.2 g/cm³.

D3: Mixture of polysaccharides; density about 1.5 g/cm³.

The particle size distributions were verified by laser diffraction (Mastersizer 3000 from Malvern Panalytical, measured in water). To this end a sample of the substance to be analyzed was taken with a small measuring spoon (about 150 mg) and placed in a 50 ml beaker. 0.75 ml of a 5% aqueous solution of an emulsifier (nonylphenol polyglycol ether having 9 ethoxy units) were added and 3 drops of 2-propanol were added using a plastic pipette (3 ml with 0.5 ml graduation). The mixture was made up with 20 ml of demineralized water and stirred with a blade stirrer for 3 minutes at 1000 rpm without touching the walls of the beaker with the stirrer. After stirring, the sample was placed in a cooled ultrasonic bath for 3 minutes and then immediately examined by laser diffraction. Measurement was carried out according to the operating instructions for the employed instrument (Mastersizer 3000 from Malvern Panalytical).

### Production Example 1 (Inventive)

The dry comminution of wax (W1 (Licowax® PE 130 granules), W8 (Licocare RBW 102 FL VITA)) for production of the inventive micronized wax composition (C) was carried out using a Zirkoplex classifier mill ZPS 200 (Hosokawa Alpine AG) with a classifier wheel or using an AFG 200 fluidized bed counterjet mill (Hosokawa Alpine AG) with an integrated classifier.

The dry comminution was initially carried out without emulsifier to adjust the apparatus-specific parameters so as to attain micronized waxes having D50 values of the particle size distribution in the range from 5 to 15 μm, D90 values in the range from 10 to 40 μm, and D99 values in the range from 15 to 70 μm.

The material comprised the wax (W) and, if present, the density additive (D) as a solid mixture. The particle size distributions were verified by laser diffraction (Mastersizer 3000 from Malvern Panalytical, measured in water) as described above. After achieving the particle size distribution in the specified range the parameters were kept constant.

To produce the wax composition (C) the emulsifier was then sprayed from the side onto the grinding disc (ZPS 200) or directly into the grinding chamber (AFG 200) over a period of 5 to 40 minutes during grinding.

For production of the micronized wax W3 the process was accordingly carried out without density additive (D) and without addition of an emulsifier.

The conditions and results of the dry comminution are shown in table 1 (ZPS 200) and table 2 (AFG200).

TABLE 1

| | Composition (C) | | | | | | |
|---|---|---|---|---|---|---|---|
| | C1 | C2 | C3 | C4 | C5 | C6 | C7 |
| | Wax (W) | | | | | | |
| | W1 | W1 | W1 | W1 | W1 | W1 | W1 |
| | Emulsifier (E) | | | | | | |
| | E1 | E1 | E1 | E1 | E1 | E1 | E1 |
| Proportion of (E) | 1.2 | 2.7 | 3.2 | 3.3 | 2.5 | 0.9 | 4.1 |
| [w/w %]* | | | | | | | |
| Density [g/cm³] | 0.97 | 0.97 | 0.97 | 0.976 | 0.97 | 0.97 | 0.97 |
| D50 [μm] | 8.48 | 8.91 | 9.14 | 8.87 | 9.28 | 9.37 | 14.4 |
| D90 [μm] | 17.5 | 17.9 | 18.5 | 17.4 | 18.4 | 18.2 | 35.7 |
| D99 [μm] | 26.4 | 26.5 | 28.5 | 25.9 | 27.2 | 26.4 | 60.0 |

*Employed amount based on the weight of all employed components

TABLE 2

| | C8 | C9 | C10 | C11 | C12 | C13 |
|---|---|---|---|---|---|---|
| | Wax (W) | | | | | |
| | W2 | W1 | W1 | W1 | W1 | W8 |
| | Emulsifier (E) | | | | | |
| | E1 | E1 | E1 | E1 | E2 | E1 |
| Proportion of (E) | 2.4 | 3.4 | 3.4 | 4 | 19.1 | 3.6 |
| [w/w %]* | | | | | | |
| Density additive (D) | | D1 | D2 | D3 | | |
| Proportion of (D) | | 7 | 7.8 | 17 | | |
| [w/w %]* | | | | | | |
| Density [g/cm³] | 0.97 | 1.003 | 1.018 | 1.017 | 0.98 | 0.987 |
| D50 [μm] | 9.4 | 8.6 | 9.63 | 6.68 | 5.5 | 8.4 |
| D90 [μm] | 24.5 | 24.6 | 23.2 | 14.9 | 11 | 16.3 |
| D99 [μm] | 44.2 | 48.2 | 38.6 | 24.4 | 16.2 | 28.3 |

*Employed amount based on the weight of all employed components

### Production Example 2 (Comparative)

The micronized wax W3 was blended in a dry state with 3% by weight (composition V1) or with 18% by weight (composition V2) of the emulsifier E1 (at 2000 RPM) using a Hausschild SpeedMixer® DAC 150 (Hausschild GmbH & Co. KG).

### Example 1 (Flowability)

A downpipe (open glass cylinder; 20 cm height, 1.5 cm diameter) was placed on a dark test mat so that the lower opening of the test mat was sealed by the test mat. 2.5 g of the respective micronized wax composition (table 3) were filled into the downpipe from above. The downpipe was lifted from the mat to a distance of about 2 cm, so that the wax powder could fall out to form a powder cone. The diameter of the resulting powder cone was measured with a ruler. A flatter, wider powder cone implies better flowability.

The tests show, first, that flowability is better at a low emulsifier content and, second, that dry comminution of the wax in the presence of the emulsifier achieves a better flowability than when the emulsifier is blended with the micronized wax only after the micronization.

TABLE 3

| Composition | V1 | V2 | C4 |
|---|---|---|---|
| Wax (W) | W3 | W3 | W1 |
| D50 [μm] | 7.5-9.5 | 7.5-9.5 | 8.87 |
| Emulsifier (E) | E1 | E1 | E1 |
| Emulsifier content [% by wt.] | 3 | 18 | 3 |
| Powder cone diameter [mm] | about 45 | about 40 | about 50 |

### Example 2 (Dispersibility)

35% by weight of a micronized wax composition were dispersed in an aqueous solution containing 64.7% by weight of demineralized water, 0.1% by weight of thickener (xanthan gum), 0.1% by weight of defoamer (Tego® Foamex 810 from Evonik Industries AG) and 0.1% by weight of antimicrobial agent (Proxel™ GXL from Arch Chemicals, Inc.) (15 min at 1500 RPM) and the duration of dispersion stability was observed.

Stable dispersions with wax W3 were producible in the usual manner only when the emulsifier E1 was initially charged in the aqueous solution first and the micronized wax W3 was introduced only subsequently. By contrast, inventive micronized wax compositions C1-C12 were directly incorporable into the aqueous solution without additional initial charging of emulsifier. Dispersion stabilities at room temperature are shown in table 4.

TABLE 4

| | E1/E2 | D1/D2/D3 | Day | Day | Day | Day | Day | Day |
|---|---|---|---|---|---|---|---|---|
| | [% by wt.] | [% by wt.] | 0 | 1 | 3 | 7 | 22 | 24 |
| W3 | 0 (E1) | 0 | − | − | − | − | − | − |
| C6 | 0.9 (E1) | 0 | + | − | − | − | − | − |
| C1 | 1.2 (E1) | 0 | + | − | − | − | − | − |
| C8 | 2.4 (E1) | 0 | + | + | + | + | + | + |
| C5 | 2.5 (E1) | 0 | + | + | + | + | + | + |
| C2 | 2.7 (E1) | 0 | + | + | + | + | + | + |
| C3 | 3.2 (E1) | 0 | + | + | + | + | + | + |
| C4 | 3.3 (E1) | 0 | + | + | + | + | + | + |
| C7 | 4.1 (E1) | 0 | + | + | + | + | + | + |
| C9 | 3.4 (E1) | 7 (D1) | + | + | + | + | + | + |
| C10 | 3.4 (E1) | 7.8 (D2) | + | + | + | + | + | + |
| C11 | 4 (E1) | 17 (D3) | + | + | + | + | + | + |
| C12 | 19.1 (E2) | 0 | + | + | + | + | + | + |

(+: stable; −: separation)

Above an emulsifier amount of 2.5% by weight the inventive micronized wax compositions (C) were also dispersible in water within a short time (<2 min) by shaking, manual stirring or swaying of the respective vessel.

Dispersions containing compositions C9 to C11, which contained a density additive (D), remained stable for longer and showed a different phase separation behavior after long storage (the solids did not float on the aqueous solution but sank below the water surface to a greater extent due to the elevated density). This also further favors redispersibility in the case of phase separation after prolonged storage.

### Example 3 (Dispersibility Compared to Polar Modified Waxes)

90 g of demineralized water were initially charged in a 250 ml beaker and 10 g of the micronized wax composition C4 or one of the polar waxes W4, W6 or W7 were added to the water surface. A blade stirrer was then immersed in the water to the extent that the distance to the beaker bottom was just a few millimeters.

The stirring operation at 700 rpm was commenced and then terminated after 5 min. The blade stirrer was then moved upward and the mixtures were observed. After 2 hours observation was terminated.

In the micronized wax composition C4, wetting of the solid with water was observed even before commencement of stirring. In the waxes W4, W6 and W7 the wax floated without visible wetting.

In the case of waxes W4, W6 and W7 termination of the stirring operation was immediately followed by complete separation of the mixtures with formation of a clear water phase with the wax floating thereupon. By contrast, the micronized wax composition C4 formed a stable and homogeneous wax dispersion, which showed no visible changes even after 2 hours.

### Example 4 (Water-Based 1-Component Polyurethane Lacquer)

An aqueous formulation was produced by initially charging a ready-to-use water-based 1-component polyurethane lacquer (for example Bona Mega from Bona Vertriebsgesellschaft mbH) and slowly or quickly adding a micronized wax composition or a micronized wax and using a laboratory disperser (Dispermat® LC30 from VMA-Getzmann GmbH) to effect incorporation into the lacquer over 0.5 min at 500 RPM and then over 1 min at 1000 RPM (altogether 1.5 min).

The mixture was then fixed between two slides (glass) and the visible wax agglomerates were counted.

The results are shown in table 5.

TABLE 5

| (W)/(C) | W3 | | W4 | | W5 | W6 | V1 | V2 | C7 | |
|---|---|---|---|---|---|---|---|---|---|---|
| Amount of lacquer [% by wt.] | 98 | | 98 | | 98 | 98 | 98 | 98 | 98 | |
| Amount (W)/(C) [w/w %] | 2 | | 2 | | 2 | 2 | 2 | 2 | 2 | |
| Agglomerates | 200 | 240^{a)} | 129 | 142^{a)} | >114 | >137 | >200 | 98 | 20 | 15^{a)} |

^{a)}fast addition

TABLE 6

| (W)/(C) | W9 | C13 |
|---|---|---|
| Amount of lacquer | 98 | 98 |
| [% by wt.] | | |
| Amount (W)/(C) | 2 | 2 |
| [w/w %] | | |

| | | | | |
|---|---|---|---|---|
| Agglomerates | >300 | >300 ^{a)} | 81 | 96 ^{a)} |

^{a)} fast addition

Only at markedly higher stirrer speeds and markedly longer dispersing times (20 min at 2000 RPM) were homogeneous dispersions comprising <50 agglomerates detectable for comparative formulations.

It is clearly apparent from these results that the micronized wax compositions (C) according to the invention are incorporable into water-based lacquers much faster and much more homogeneously than commercially available waxes (unmodified and modified) or wax compositions where the emulsifier was added only after the micronization (V1, V2).

Similar results are also observable for 1-component acrylic lacquers and printing inks for flexography.

### Example 5 (Scratch Resistance of Lacquers)

1-component polyurethane lacquers were produced as in example 4, wherein dispersion was carried out for 20 min at 2000 RPM. The dispersion time of 20 min was selected in order also to allow homogeneous incorporation of the comparative examples W3 and W4. In the case of shorter dispersion times these were in the lacquer in the form of agglomerates so that lacquer surfaces produced therefrom that were to be tested were likewise inhomogeneous and thus untestable. The inventive wax compositions (C) are testable even after incorporation according to example 4.

The formulations were applied to a glass plate and hardened and their scratch resistance was examined.

This was done using the hardness test pencil method (DIN EN ISO 1518-1:2019) and the Schmiss test (ASTM 5178-21). The results are shown in table 6.

TABLE 7

| (W)/(C) | | W3 | W4 | C4 | C5 | C7 |
|---|---|---|---|---|---|---|
| Amount of lacquer [% by wt.] | 100 | 98 | 98 | 98 | 98 | 98 |
| Amount (W)/(C) [w/w %] | 0 | 2 | 2 | 2 | 2 | 2 |
| Hardness test pencil [N] | 0.6 | 0.9 | 0.7 | 1.0 | 1.0 | 1.2 |
| Schmiss test [N] | 0.7 | 0.9 | 0.4 | 1.2 | 1.4 | 1.6 |

1-component acrylic lacquers with micronized waxes/wax compositions were produced in similar fashion and their scratch resistance was examined according to DIN EN ISO 1518-1:2019. The results are shown in table 7.

TABLE 8

| (W)/(C) | | W3 | W4 | C2 | C3 | C4 | C5 | C7 |
|---|---|---|---|---|---|---|---|---|
| Amount of lacquer [% by wt.] | 100 | 98 | 98 | 98 | 98 | 98 | 98 | 98 |
| Amount (W)/(C) [w/w %] | 0 | 2 | 2 | 2 | 2 | 2 | 2 | 2 |
| Hardness test pencil [N] | 0.2 | 1.3 | 1.2 | 1.5 | 1.5 | 1.6 | 1.4 | 1.6 |
| Amount of lacquer [% by wt.] | 100 | 96 | 96 | 96 | 96 | 96 | 96 | 96 |
| Amount (W)/(C) [w/w %] | 0 | 4 | 4 | 4 | 4 | 4 | 4 | 4 |
| Hardness test pencil [N] | 0.2 | 1.2 | 1.3 | 1.7 | 1.6 | 1.7 | 1.5 | 1.7 |

It is apparent from the results that lacquers containing the inventive micronized wax compositions (C) have a comparable or higher scratch resistance than lacquers with commercially available waxes (unmodified and modified).

1-22. (canceled)

23. A process for producing a micronized wax composition (C) comprising the step of performing dry comminution on at least one wax (W) in the presence of:
at least one emulsifier (E),
optionally, at least one density additive (D), and
optionally, at least one further additive (A),
wherein
the at least one density additive (D) has a density at 20° C. of >1 g/cm³ and is substantially insoluble in water at 20° C.;
the at least one further additive (A) is distinct from the at least one wax (W), the at least one emulsifier (E), and the at least one density additive (D); and
dry comminution is performed with less than 20% by weight of water based on the amount of wax (W) employed for comminution.

24. The process according to claim 23, wherein the at least one emulsifier (E) is present in liquid or dissolved form during comminution.

25. The process according to claim 23, wherein the wax (W) essentially does not form a stable dispersion in water.

26. The process according to claim 23, wherein the density additive (D) is an organic additive selected from halogenated organic polymers and polysaccharides.

27. The process according to claim 26, wherein the density additive (D) is selected from polytetrafluoroethylene wax, cellulose, and hemicellulose.

28. The process according to claim 23, wherein the density additive (D) is an inorganic additive.

29. The process according to claim 28, wherein the density additive (D) is selected from selected from salts of alkaline earth metals.

30. The process according to claim 29, wherein the density additive (D) is selected from calcium sulfate, calcium carbonate, barium sulfate, and barium carbonate.

31. The process according to claim 23, wherein the following amounts of components are employed in the comminution:
a) from 40% to 99.9% by weight, based on the weight of the employed components, of the at least one wax (W);
b) from 0.1% to 20% by weight, based on the weight of the employed components, of the at least one emulsifier (E);
c) from 0% to 59.9% by weight, based on the weight of the employed components, of the at least one density additive (D); and
d) from 0% to 50% by weight, based on the weight of the employed components, of the at least one further additive (A).

32. The process according to claim 23, wherein
the wax (W) is selected from the group consisting of synthetic organic waxes, semisynthetic organic waxes, natural waxes, and mixtures thereof; and
the wax is optionally oxidized or otherwise chemically modified.

33. The process according to claim 23, wherein the wax (W) is selected from polyolefin waxes, montan wax, rice bran wax, beeswax, sunflower wax, corn wax, carnauba wax, Fischer-Tropsch waxes, paraffin waxes, ester waxes, and amide waxes.

34. The process according to claim 33, wherein the wax (W) is selected from polyethylene wax, polypropylene wax, poly(ethylene-co-propylene) wax, rice bran wax, corn wax, sunflower wax, and an HDPE wax.

35. The process according to claim 23, further comprising the step of introducing the emulsifier (E) to the wax (W) by spraying the emulsifier (E) in liquid or dissolved form during comminution of the wax (W).

36. The process according to claim 23, wherein the wax (W) is not oxidized, is not grafted with heteroatom-containing groups, and contains no polar groups.

37. The process according to claim 23, wherein the wax (W) contains polar groups and is oxidized or is grafted with heteroatom-containing groups.

38. The process according to claim 23, wherein the density additive (D) is present in an amount such that the density of the micronized wax composition (C) at 20° C. is in the range of from 0.94 g/cm³ to 1.20 g/cm³.

39. The process according to claim 23, wherein dry comminution of wax (W) is performed until a volume median value D₅₀ of wax (W) particles is in the range of from 3 μm to 30 μm.

40. A micronized wax composition (C) obtained by the process according to claim 1, the composition comprising:
a) at least one wax (W);
b) at least one emulsifier (E);
c) optionally, at least one density additive (D) having a density at 20° C. of >1 g/cm³, wherein the density additive (D) is substantially insoluble in water at 20° C.; and
d) optionally at least one further additive (A) distinct from the at least one wax (W), the at least one emulsifier (E) and the at least one density additive (D),
wherein the water content of the micronized wax composition (C) is less than 20% by weight, based on the total weight of the micronized wax composition (C).

41. The micronized wax composition (C) according to claim 40, comprising:
a) 40% to 99.9% by weight, based on the weight of the micronized wax composition (C), of the at least one wax (W);
b) 0.1% to 20% by weight, based on the weight of the micronized wax composition (C), of the at least one emulsifier (E);
c) optionally 0% to 59.9% by weight, based on the weight of the micronized wax composition (C), of the at least one density additive (D); and
d) optionally 0% to 50% by weight, based on the weight of the micronized wax composition (C), of the at least one further additive (A).

42. A process for producing an aqueous formulation comprising the steps of:
(i) obtaining the micronized wax composition (C) according to claim 40 by performing dry comminution on at least one wax (W) in the presence of at least one emulsifier (E),
optionally, at least one density additive (D), and
optionally, at least one further additive (A)
wherein
the at least one density additive (D) has a density at 20° C. of >1 g/cm3 and is substantially insoluble in water at 20° C.;
the at least one further additive (A) is distinct from the at least one wax (W), the at least one emulsifier (E), and the at least one density additive (D); and
dry comminution is performed with less than 20% by weight of water based on the amount of wax (W) employed for comminution;
(ii) mixing the micronized wax composition (C) of step (i), water, and, optionally, further components;
wherein step (i) is carried out immediately before step (ii) or the micronized wax composition (C) of step (i) is stored until the mixing of step (ii).
